(19) United States
(12) Patent Application Publication
(10) Pub. No.: US 2022/0291016 A1
(43) Pub. Date: Sep. 15, 2022

(54) VEHICLE POSITION RECOGNITION APPARATUS

(71) Applicant: Honda Motor Co., Ltd., Tokyo (JP)

(72) Inventor: Naoki Mori, Wako-shi (JP)

(21) Appl. No.: 17/676,197

(22) Filed: Feb. 20, 2022

(30) Foreign Application Priority Data
Mar. 9, 2021 (JP) 2021-037059

(51) Int. Cl. G01C 21/00

(52) U.S. Cl. CPC G01C 21/3859; G01C 21/3837

(57) ABSTRACT

Vehicle position recognition apparatus includes: processor and memory. Memory is configured to store: first map information of first map of first area; and second map information of second map of second area adjacent to first area through overlapped area between first area and second area. Processor is configured to perform: recognizing first/second position of vehicle in overlapped area based on first/second map information stored in memory; generating first/second traveling locus of vehicle in overlapped area based on change with time in first/second position recognized; and updating first map information so that first traveling locus and second traveling locus are matched when first traveling locus and second traveling locus are superposed based on first traveling locus and second traveling locus generated.

### CROSS-REFERENCE TO RELATED APPLICATION

This application is based upon and claims the benefit of priority from Japanese Patent Application No. 2021-037059 filed on Mar. 9, 2021, the content of which is incorporated herein by reference.

### BACKGROUND OF THE INVENTION

### Field of the Invention

This invention relates to a vehicle position recognition apparatus configured to recognize a position of a vehicle.

### Description of the Related Art

Conventionally, as this type of apparatus, an apparatus configured to perform travel control of a self-driving vehicle is known (for example, see Japanese Unexamined Patent Application Publication No. 2019-64562 (JP2019-064562A)). In an apparatus described in JP2019-064562A, a self-position of a vehicle is estimated by recognizing the outside world around the vehicle, high-precision road map information is sequentially extracted from road map information database based on the self-position, and travel control of the vehicle is performed using the extracted map information.

Meanwhile, the vehicle may travel in boundary regions of a plurality of maps adjacent to each other. However, since there is a case where an inherent error is included in the map information of adjacent maps, when the self-position is estimated as in the apparatus described in JP2019-064562A, the estimation result of the self-position may vary, and in an apparatus that controls the traveling operation based on the map information, it may be difficult to perform smooth traveling control when traveling in a boundary region of a plurality of maps.

### SUMMARY OF THE INVENTION

An aspect of the present invention is a vehicle position recognition apparatus, including: a processor and a memory connected to the processor. The memory is configured to store: first map information of a first map of a first area; and second map information of a second map of a second area adjacent to the first area through an overlapped area between the first area and the second area. The processor is configured to perform: recognizing a first position of a vehicle in the overlapped area based on the first map information stored in the memory; recognizing a second position of the vehicle in the overlapped area based on the second map information stored in the memory; generating a first traveling locus of the vehicle in the overlapped area based on a change with time in the first position recognized; generating a second traveling locus of the vehicle in the overlapped area based on a change with time in the second position recognized; and updating the first map information so that the first traveling locus and the second traveling locus are matched when the first traveling locus and the second traveling locus are superposed based on the first traveling locus and the second traveling locus generated.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of a travel scene of a self-driving vehicle to which a vehicle position recognition apparatus according to an embodiment of the present invention is applied;

FIG. 2 is a block diagram schematically illustrating an overall configuration of a vehicle control system of the self-driving vehicle to which the vehicle position recognition apparatus according to the embodiment of the present invention is applied;

FIG. 3 is a diagram illustrating an example of a traveling scene of the self-driving vehicle assumed by the vehicle position recognition apparatus according to the embodiment of the present invention;

FIG. 4 is a block diagram illustrating a main configuration of the vehicle position recognition apparatus according to the embodiment of the present invention;

FIG. 5A is a diagram illustrating an example of a traveling locus generated based on internal map information by a traveling locus generation unit of FIG. 4;

FIG. 5B is a diagram illustrating an example of a traveling locus generated based on external map information by the traveling locus generation unit of FIG. 4;

FIG. 6 is a diagram for explaining updating of the internal map information by a map information updating unit of FIG. 4; and

FIG. 7 is a flowchart illustrating an example of processing executed by a controller of FIG. 4.

### DETAILED DESCRIPTION OF THE INVENTION

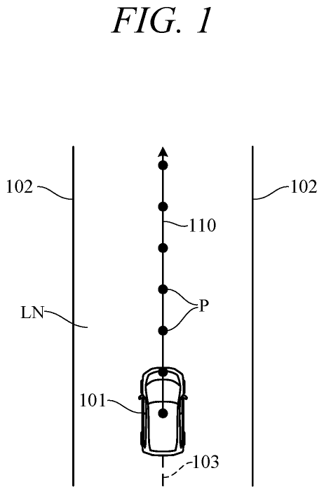

An embodiment of the present invention will be described below with reference to FIGS. 1 to 7. A vehicle position recognition apparatus according to the embodiment of the present invention can be applied to a vehicle having an automatic driving function (self-driving vehicle). The self-driving vehicle includes not only a vehicle that performs only traveling in a self-driving mode in which a driving operation by a driver is unnecessary, but also a vehicle that performs traveling in a self-driving mode and traveling in a manual driving mode by a driving operation by a driver.

FIG. 1 is a diagram illustrating an example of a travel scene of a self-driving vehicle (hereinafter, a vehicle) 101. FIG. 1 illustrates an example in which the vehicle 101 travels (lane-keep travel) while following a lane so as not to deviate from a lane LN defined by lane markers 102. Note that the vehicle 101 may be any of an engine vehicle having an internal combustion engine as a traveling drive source, an electric vehicle having a traveling motor as a traveling drive source, and a hybrid vehicle having an engine and a traveling motor as traveling drive sources.

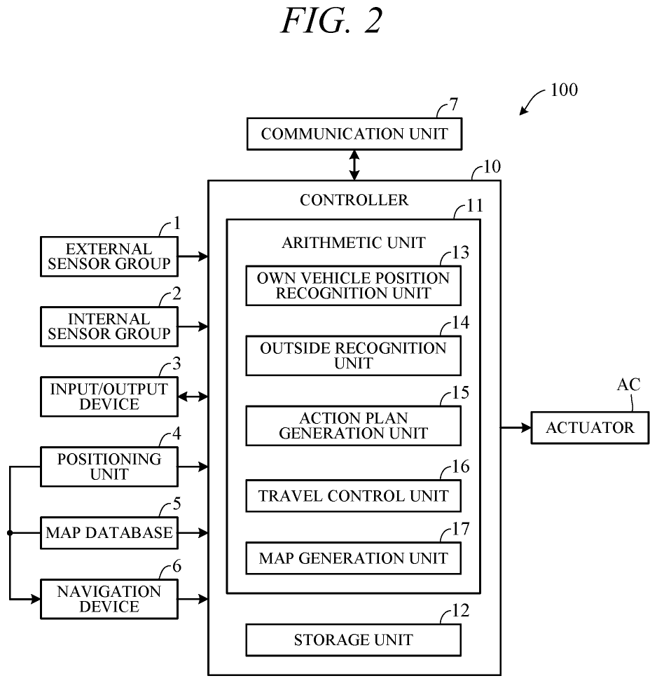

FIG. 2 is a block diagram schematically illustrating an overall configuration of a vehicle control system 100 of the vehicle 101 to which a vehicle position recognition apparatus according to the present embodiment is applied. As illustrated in FIG. 2, the vehicle control system 100 mainly includes a controller 10, an external sensor group 1, an internal sensor group 2, an input/output device 3, a positioning unit 4, a map database 5, a navigation device 6, a communication unit 7, and a traveling actuator AC each electrically connected to the controller 10.

The external sensor group 1 is a generic term for a plurality of sensors (external sensors) that detect an external environment which is peripheral information of the vehicle 101 (FIG. 1). For example, the external sensor group 1 includes a LiDAR that measures scattered light with respect to irradiation light in all directions of the vehicle 101 and measures a distance from the vehicle 101 to a surrounding obstacle, a radar that detects another vehicle, an obstacle, or the like around the vehicle 101 by irradiating electromagnetic waves and detecting a reflected wave, and a camera that is mounted on the vehicle 101 and has an imaging element such as a CCD or a CMOS to image the periphery of the vehicle 101 (forward, aft and lateral).

The internal sensor group 2 is a generic term for a plurality of sensors (internal sensors) that detect a traveling state of the vehicle 101. For example, the internal sensor group 2 includes a vehicle speed sensor that detects the vehicle speed of the vehicle 101, an acceleration sensor that detects the acceleration in the front-rear direction and the acceleration (lateral acceleration) in the left-right direction of the vehicle 101, a rotation speed sensor that detects the rotation speed of the traveling drive source, a yaw rate sensor that detects the rotation angular speed around the vertical axis of the center of gravity of the vehicle 101, and the like. The internal sensor group 2 further includes a sensor that detects driver's driving operation in a manual driving mode, for example, operation of an accelerator pedal, operation of a brake pedal, operation of a steering wheel, and the like.

The input/output device 3 is a generic term for devices to which a command is input from a driver or from which information is output to the driver. For example, the input/output device 3 includes various switches to which the driver inputs various commands by operating an operation member, a microphone to which the driver inputs a command by voice, a display that provides information to the driver with a display image, a speaker that provides information to the driver by voice, and the like.

The positioning unit (GNSS unit) 4 has a positioning sensor that receives a positioning signal transmitted from a positioning satellite. The positioning satellite is an artificial satellite such as a GPS satellite or a quasi-zenith satellite. The positioning unit 4 measures a current position (latitude, longitude, altitude) of the vehicle 101 by using the positioning information received by the positioning sensor.

The map database 5 is a device that stores general map information used in the navigation device 6, and is constituted of, for example, a hard disk or a semiconductor element. The map information includes road position information, information on a road shape (curvature or the like), and position information on intersections and branch points. The map information stored in the map database 5 is different from high-precision map information stored in a storage unit 12 of the controller 10.

The navigation device 6 is a device that searches for a target route on a road to a destination input by a driver and provides guidance along the target route. The input of the destination and the guidance along the target route are performed via the input/output device 3. The target route is calculated based on a current position of the vehicle 101 measured by the positioning unit 4 and the map information stored in the map database 5. The current position of the vehicle 101 can be measured using the detection values of the external sensor group 1, and the target route may be calculated based on the current position and the high-precision map information stored in the storage unit 12.

The communication unit 7 communicates with various servers (not illustrated) via a network including a wireless communication network represented by the Internet network, a mobile phone network, or the like, and acquires map information, travel history information, traffic information, and the like from the servers periodically or at an arbitrary timing. The travel history information of the vehicle 101 may be transmitted to the server via the communication unit 7 in addition to the acquisition of the travel history information. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the storage unit 12, and the map information is updated.

The actuator AC is a traveling actuator for controlling traveling of the vehicle 101. When the traveling drive source is an engine, the actuator AC includes a throttle actuator that adjusts an opening degree of a throttle valve of the engine and an injector actuator that adjusts a valve opening timing and a valve opening time of the injector. When the traveling drive source is a traveling motor, the traveling motor is included in the actuator AC. The actuator AC also includes a brake actuator that operates the braking device of the vehicle 101 and a steering actuator that drives the steering device.

The controller 10 includes an electronic control unit (ECU). More specifically, the controller 10 includes a computer including an arithmetic unit 11 such as a CPU (microprocessor), the storage unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, the controller 10 is illustrated, in FIG. 2, as a set of these ECUs for convenience.

The storage unit 12 stores highly accurate detailed road map information for traveling. The road map information includes road position information, information of a road shape (curvature or the like), information of a road gradient, position information of an intersection or a branch point, information of type and position of lane markers such as white lines, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface.

The map information stored in the storage unit 12 includes map information (referred to as external map information) acquired from the outside of the vehicle 101 via the communication unit 7 and map information (referred to as internal map information) created by the vehicle 101 itself using detection values of the external sensor group 1 or detection values of the external sensor group 1 and the internal sensor group 2.

The external map information is, for example, information of a general-purpose map (referred to as a cloud map) generated based on data collected by a dedicated surveying vehicle or a general self-driving vehicle traveling on a road and distributed to the general self-driving vehicle via a cloud server. The external map is generated for an area with a large traffic volume such as a highway or an urban area, but is not generated for an area with a small traffic volume such as a residential area or a suburb.

On the other hand, the internal map information is information of a map (referred to as an environment map) including point cloud data generated by mapping using a technology such as simultaneous localization and mapping (SLAM) based on data collected by each self-driving vehicle traveling on a road. The external map information is shared by the vehicle 101 and other self-driving vehicles, whereas the internal map information is dedicated map information (for example, map information that the vehicle 101 independently has) generated by the vehicle 101 and used for self-driving of the vehicle 101. In a region where external map information is not provided, such as a newly constructed road, an environment map is created by the vehicle 101 itself. Note that the internal map information may be provided to a server device or another self-driving vehicle via the communication unit 7.

The storage unit 12 also stores information such as various control programs and a threshold used in the programs.

The arithmetic unit 11 includes an own vehicle position recognition unit 13, an outside recognition unit 14, an action plan generation unit 15, a travel control unit 16, and a map generation unit 17 as functional configurations. In other words, the arithmetic unit 11 such as a CPU (microprocessor) of the controller 10 functions as the own vehicle position recognition unit 13, outside recognition unit 14, action plan generation unit 15, travel control unit 16, and map generation unit 17.

The own vehicle position recognition unit 13 highly accurately recognizes the position of the vehicle 101 on the map (own vehicle position) based on the highly accurate detailed road map information (external map information, internal map information) stored in the storage unit 12 and the peripheral information of the vehicle 101 detected by the external sensor group 1. When the own vehicle position can be measured by a sensor installed on the road or outside a road side, the own vehicle position can be recognized by communicating with the sensor via the communication unit 7. The own vehicle position may be recognized using the position information of the vehicle 101 obtained by the positioning unit 4. The movement information (moving direction, moving distance) of the own vehicle may be calculated based on the detection values of the internal sensor group 2, and the own vehicle position may be recognized accordingly.

The outside recognition unit 14 recognizes an external environment around the vehicle 101 based on the signal from the external sensor group 1 such as a LiDAR, a radar, and a camera. For example, the position, speed, and acceleration of a surrounding vehicle (a front vehicle or a rear vehicle) traveling around the vehicle 101, the position of a surrounding vehicle stopped or parked around the vehicle 101, and the positions and states of other objects are recognized. Other objects include signs, traffic lights, signs such as lane markers (white lines, etc.) or stop lines on roads, buildings, guardrails, utility poles, signboards, pedestrians, bicycles, and the like. The states of other objects include a color of a traffic light (red, green, yellow), the moving speed and direction of a pedestrian or a bicycle, and the like. A part of the stationary object among the other objects constitutes a landmark serving as an index of the position on the map, and the outside recognition unit 14 also recognizes the position and type of the landmark.

The action plan generation unit 15 generates a traveling path (target path) of the vehicle 101 from a current point of time to a predetermined time ahead based on, for example, the target route calculated by the navigation device 6, the map information stored in the storage unit 12, the own vehicle position recognized by the own vehicle position recognition unit 13, and the external environment recognized by the outside recognition unit 14. More specifically, the target path of the vehicle 101 is generated on the external map or the internal map based on the external map information or the internal map information stored in the storage unit 12. When there are a plurality of paths that are candidates for the target path on the target route, the action plan generation unit 15 selects, from the plurality of paths, an optimal path that satisfies criteria such as compliance with laws and regulations and efficient and safe traveling, and sets the selected path as the target path. Then, the action plan generation unit 15 generates an action plan corresponding to the generated target path.

The action plan includes travel plan set for each unit time (for example, 0.1 seconds) from a current point of time to a predetermined time (for example, 5 seconds) ahead, that is, travel plan set in association with a time for each unit time. The travel plan includes information on an own vehicle position of the vehicle 101 and information on a vehicle state per unit time. The own vehicle position information is, for example, two-dimensional coordinate position information on a road, and the vehicle state information is vehicle speed information indicating a vehicle speed, direction information indicating a direction of the vehicle 101, and the like. Therefore, when the vehicle is supposed to accelerate to a target vehicle speed within a predetermined time, the information of the target vehicle speed is included in the action plan. The vehicle state can be obtained from a change in the own vehicle position per unit time. The travel plan is updated every unit time.

FIG. 1 illustrates an example of the action plan generated by the action plan generation unit 15, that is, a travel plan of a scene in which the vehicle 101 travels in the lane-keep travel so as not to deviate from the lane LN. Each point P in FIG. 1 corresponds to the own vehicle position for each unit time from the current point in time to a predetermined time ahead, and the target path 110 is obtained by connecting these points P in time order. The target path 110 is generated, for example, along the center line 103 of the pair of lane markers 102 defining the lane LN. The target path 110 may be generated along a past travel path (traveling locus) included in the map information. Note that the action plan generation unit 15 generates various action plans corresponding to overtaking travel in which the vehicle 101 moves to another lane and overtakes the preceding vehicle, lane change travel in which the vehicle moves to another lane, deceleration travel, acceleration travel, or the like, in addition to the lane-keep travel. When generating the target path 110, the action plan generation unit 15 first determines a travel mode and generates the target path 110 based on the travel mode. The information on the target path 110 generated by the action plan generation unit 15 is added to the map information and stored in the storage unit 12, and is taken into consideration when the action plan generation unit 15 generates an action plan at the time of the next travel.

In the self-driving mode, the travel control unit 16 controls each of the actuators AC so that the vehicle 101 travels along the target path 110 generated by the action plan generation unit 15. More specifically, the travel control unit 16 calculates a requested driving force for obtaining the target acceleration for each unit time calculated by the action plan generation unit 15 in consideration of travel resistance determined by a road gradient or the like in the self-driving mode. Then, for example, the actuator AC is feedback controlled so that an actual acceleration detected by the internal sensor group 2 becomes the target acceleration. That is, the actuator AC is controlled so that the vehicle 101 travels at the target vehicle speed and the target acceleration. In the manual driving mode, the travel control unit 16 controls each actuator AC in accordance with a travel command (steering operation or the like) from the driver acquired by the internal sensor group 2.

The map generation unit 17 generates, while traveling in the manual driving mode, an environment map including three-dimensional point cloud data in an absolute latitude-longitude coordinate system by using the detection values detected by the external sensor group 1 and the current position (absolute latitude-longitude) of the vehicle 101 measured by the positioning unit 4. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 calculates the distance to the extracted feature point and sequentially plots the feature point on the environment map, thereby generating the environment map around the road on which the subject vehicle has traveled. The environment map may be generated by extracting the feature point of an object around the subject vehicle using data acquired by radar or LiDAR instead of the camera.

The own vehicle position recognition unit 13 performs own vehicle position estimation processing in parallel with map generation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual driving mode but also when the vehicle travels in the self-driving mode. If the environment map has already been generated and stored in the storage unit 12, the map generation unit 17 may update the environment map with a newly obtained feature point.

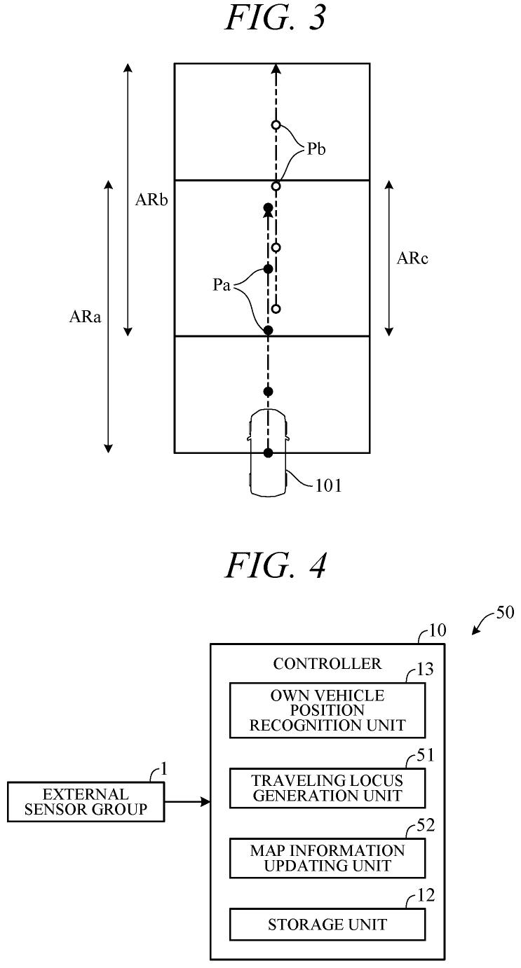

A configuration of the vehicle position recognition apparatus according to the present embodiment will be described. FIG. 3 is a diagram illustrating an example of a traveling scene of the vehicle 101 assumed by the vehicle position recognition apparatus according to the present embodiment, and illustrates a scene in which the vehicle 101 travels in the lane-keep travel so as not to deviate from the lane LN as in FIG. 1. Hereinafter, an area that an internal map such as an environment map is stored in the storage unit 12 is referred to as an internal map area ARa, and an area that an external map such as a cloud map is stored in the storage unit 12 is referred to as an external map area ARb.

Each piece of map information includes an inherent error due to a measurement error of absolute latitude and longitude when the map is generated. Therefore, as illustrated in FIG. 3, the own vehicle position Pa recognized based on the internal map information by the own vehicle position recognition unit 13 may not coincide with the own vehicle position Pb recognized based on the external map information. In this case, the recognition results of the own vehicle positions Pa and Pb vary at the timing when the map information used for the recognition of the own vehicle position by the own vehicle position recognition unit 13 is switched.

In this manner, it may be difficult to perform smooth travel control of the vehicle 101 when the vehicle travels in the self-driving mode in the boundary region between the internal map area ARa and the external map area ARb in a state where the recognition result of the own vehicle position varies. For example, when the recognition result of the own vehicle position varies in the traveling direction of the vehicle 101, and the own vehicle position is switched from the point Pa behind in the traveling direction to the point Pb ahead in the traveling direction at the timing when the map information is switched, it is erroneously recognized that the vehicle 101 has traveled too much with respect to the travel plan. In this case, the vehicle 101 may perform sudden decelerating or sudden braking, which causes discomfort to the occupant of the vehicle 101 and the surrounding vehicle.

Similarly, when the variation in the recognition result of the own vehicle position occurs in the opposite direction of the traveling direction of the vehicle 101, the vehicle 101 is erroneously recognized as being delayed with respect to the travel plan, and the vehicle 101 may be suddenly accelerated. In addition, when the variation in the recognition result of the own vehicle position occurs in the vehicle width direction of the vehicle 101, the vehicle 101 may be erroneously recognized as deviating from the target path 110, and the vehicle 101 may make a sudden turn.

Therefore, according to the present embodiment, an error unique to a plurality of maps is grasped as a relative positional relationship between the maps, and the plurality of maps are accurately combined so that a recognition result of the own vehicle position does not vary. In other words, the vehicle position recognition apparatus is configured as follows so that variations in the recognition result of the vehicle position can be eliminated by accurately combining the plurality of maps in advance, and smooth travel control can be performed when traveling in the boundary regions of the plurality of maps.

FIG. 4 is a block diagram illustrating a main configuration of the vehicle position recognition apparatus 50 according to the embodiment of the present invention. The vehicle position recognition apparatus 50 constitutes a part of the vehicle control system 100 in FIG. 2. As illustrated in FIG. 4, the vehicle position recognition apparatus 50 includes the controller 10 and the external sensor group 1. The controller 10 of FIG. 4 includes a traveling locus generation unit 51 and a map information updating unit 52 in addition to the own vehicle position recognition unit 13 as a functional configuration which the arithmetic unit 11 (FIG. 2) is responsible for. In other words, the arithmetic unit 11 such as a CPU (microprocessor) of the controller 10 functions as the traveling locus generation unit 51 and map information updating unit 52 in addition to the own vehicle position recognition unit 13. In the storage unit 12 of FIG. 4, the internal map information of the internal map area ARa and the external map information of the external map area ARb are stored in advance.

The traveling locus generation unit 51 generates traveling loci La and Lb when the vehicle 101 actually travels based on the own vehicle positions Pa and Pb recognized by the own vehicle position recognition unit 13 in the overlapped area ARc (FIG. 3) between the internal map area ARa and the external map area ARb. More specifically, the traveling loci La(t1 to t2) and Lb(t1 to t2) in the overlapped area ARc are generated by connecting the own vehicle positions Pa(t1, . . . , t2) and Pb(t1, . . . , t2) in the periods t1 to t2 in which both the own vehicle positions Pa and the own vehicle positions Pb are recognized in order of time.

The map information updating unit 52 updates the internal map information to superimpose the traveling locus La and the traveling locus Lb based on the traveling loci La and Lb in the overlapped area ARc generated by the traveling locus generation unit 51.

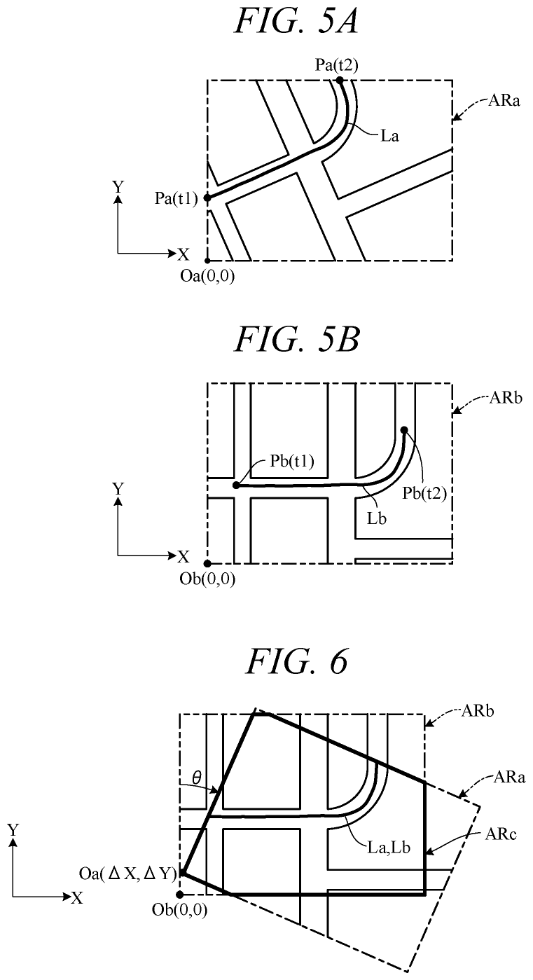

FIGS. 5A and 5B are diagrams illustrating examples of the traveling loci La and Lb generated by the traveling locus generation unit 51. FIG. 5A illustrates the traveling locus La generated based on the internal map information, and FIG. 5B illustrates the traveling locus Lb generated based on the external map information. FIG. 6 is a diagram for explaining updating of the internal map information by the map information updating unit 52.

The absolute latitude and longitude assigned to each feature point of the internal map information and the absolute latitude and longitude assigned to each feature point of the external map information may not match due to a measurement error of the absolute latitude and longitude at the time of map generation. In this case, the own vehicle positions Pa(t1, . . . , t2) recognized by collating the peripheral information around the vehicle 101 detected by the external sensor group 1 with the internal map information does not match the own vehicle positions Pb(t1, . . . , t2) recognized by collating with the external map information. Therefore, the traveling loci La and Lb generated based on the changes of the own vehicle positions Pa and Pb with the lapse of time do not coincide with each other, and different position information (coordinate values) is assigned to the traveling loci La and Lb in the same absolute latitude-longitude coordinate system (XY coordinate system) as exaggeratedly illustrated in FIGS. 5A and 5B.

In a case where the overlapped area ARc (FIG. 3) includes a characteristic road shape such as a curve or a multi-way junction, the feature points of the map information can be overlapped with each other and the maps can be combined with each other. However, in a case where the road shape of the overlapped area ARc is a simple straight road or a grid shape in which intersections having the same shape repeatedly appear, it is difficult to combine the maps by superimposing the feature points of the map information. In addition, it is also difficult to combine the maps by superimposing feature points of map information when combining maps generated before and after a position of a lane marker or a landmark, a road surface profile, or the like is changed due to road construction or the like.

On the other hand, even on a simple straight road, the traveling loci La and Lb obtained based on the actual travel history in the manual driving mode have characteristic shapes due to fluctuations in the steering operation of the driver. In addition, the traveling loci La(t1 to t2) and Lb(t1 to t2), in the same period t1 to t2, generated based on a recognition result by the own vehicle position recognition unit 13 using a single algorithm have shapes matching each other.

As illustrated in FIG. 6, the map information updating unit 52 corrects at least one piece of map information which is, for example, the absolute latitude and longitude of the internal map information so as to superimpose the traveling loci La and Lb, and updates the internal map information. More specifically, the internal map information is corrected by determining the translational movement amount (ΔX, ΔY) of the internal map in the absolute latitude-longitude coordinate system (XY coordinate system) and the rotational movement amount θ about the reference point Oa of the internal map, and the internal map information stored in the storage unit 12 is updated. For example, the translational movement amount (ΔX, ΔY) and the rotational movement amount θ of the internal map are determined by a least squares method such that a difference (for example, a difference in the Y-axis direction) between the traveling locus La and the traveling locus Lb is minimized.

In this manner, the plurality of maps can be accurately combined regardless of an inherent error included in each map by correcting the absolute latitude and longitude of the map information so as to superimpose the actual traveling loci La and Lb obtained in the overlapped area ARc. As a result, the plurality of maps used for the traveling control in the self-driving mode are accurately combined in advance, and the variation in the recognition results of the own vehicle positions Pa and Pb occurring at the timing when the map information is switched is eliminated, so that smooth travel control can be performed when the own vehicle travels in the boundary regions of the plurality of maps. The updated internal map information stored in the storage unit 12 may be transmitted to another self-driving vehicle by inter-vehicle communication, or may be transmitted to a map information management server or the like provided outside the vehicle 101. In this case, the internal map information generated on the vehicle 101 side can be shared in an effective manner by correcting the internal map information based on the external map information that is general-purpose map information and cannot be rewritten on the vehicle 101 side.

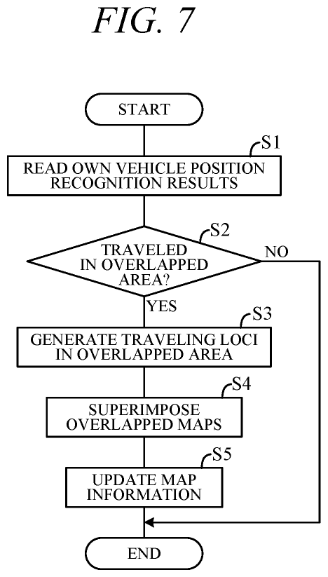

FIG. 7 is a flowchart illustrating an example of processing executed by the controller 10 of FIG. 4. The processing illustrated in this flowchart is started, for example, after the vehicle 101 travels in the manual driving mode. First, in S1 (S: processing step), recognition results of the own vehicle positions Pa and Pb which are travel histories in the manual driving mode are read. Next, in S2, based on the travel history read in S1, it is determined whether the vehicle 101 has traveled in the overlapped area ARc, that is, whether there is a period t1 to t2 in which both the own vehicle positions Pa and Pb are recognized. When the determination result is positive in S2, the process proceeds to S3, and when the determination result is negative, the process ends.

In S3, the traveling loci La(t1 to t2) and Lb(t1 to t2) in the overlapped area ARc are generated based on the recognition results of the own vehicle positions Pa(t1, . . . , t2) and Pb(t1, . . . , t2) in the overlapped area ARc. Next, in S4, the translational movement amount (ΔX, ΔY) and the rotational movement amount θ of the internal map are determined so as to superimpose the traveling loci La(t1 to t2) and Lb(t1 to t2). Next, in S5, the absolute latitude and longitude of the internal map are corrected according to the result of the superimposition in S4, the internal map information stored in the storage unit 12 is updated, and the processing is terminated.

As described above, by correcting the internal map information based on the recognition result of the position of the own vehicle when the own vehicle travels in the overlapped area ARc in the manual driving mode, smooth travel control can be performed when the own vehicle travels in the boundary region between the internal map area ARa and the external map area ARb in the self-driving mode. In other words, by accurately combining a plurality of maps used for travel control in the self-driving mode in advance, it is possible to eliminate variations in recognition results of the own vehicle positions Pa and Pb that occur at the timing when the map information is switched, and to perform smooth travel control when traveling in boundary regions of the plurality of maps.

The present embodiment can achieve advantages and effects such as the following:

(1) The vehicle position recognition apparatus 50 includes: the storage unit 12 configured to store the internal map information of the internal map area ARa and the external map information of the external map area ARb adjacent to the internal map area ARa through the overlapped area ARc between the internal map area ARa and the external map area ARb; the vehicle position recognition unit 13 configured to recognize the vehicle position Pa of the vehicle 101 in the overlapped area ARc based on the internal map information stored in the storage unit 12 and configured to recognize the vehicle position Pb of the vehicle 101 in the overlapped area ARc based on the external map information stored in the storage unit 12; the traveling locus generation unit 51 configured to generate the traveling locus La of the vehicle 101 in the overlapped area ARc based on a change with time in the vehicle position Pa recognized by the vehicle position recognition unit 13 and configured to generate the traveling locus Lb of the vehicle 101 in the overlapped area ARc based on a change with time in the vehicle position Pb recognized by the vehicle position recognition unit 13; and the map information updating unit 52 configured to update the internal map information so that the traveling locus La and the traveling locus Lb are matched when the traveling locus La and the traveling locus Lb are superposed based on the traveling loci La, Lb generated by the traveling locus generation unit 51 (FIG. 4).

In other words, the plurality of maps can be accurately combined regardless of an inherent error included in each map by correcting and updating the absolute latitude and longitude of the internal map information so as to superimpose the traveling loci La and Lb in the overlapped area ARc. As a result, variations in the recognition result of the vehicle position occurring at the timing when the map information is switched are eliminated, and smooth travel control can be performed when the vehicle travels in the boundary regions of the plurality of maps.

(2) The traveling locus generation unit 51 generates the traveling locus La (t1 to t2) and the traveling locus Lb (t1 to t2) in the time period t1 to t2 when the vehicle positions Pa, Pb have been recognized by the vehicle position recognition unit 13. In other words, the plurality of maps can be accurately combined by superimposing the traveling loci La(t1 to t2) and Lb(t1 to t2) recognized in the same period of time.

(3) The internal map, the external map, and the traveling loci La, Lb are defined in one single absolute latitude-longitude coordinate system (XY coordinate system) (FIG. 5A to FIG. 6). The map information updating unit 52 updates the internal map information by determining a translational moving amount (ΔX, ΔY) and a rotational moving amount θ of the internal map in the XY coordinate system (FIG. 6). In this case, for example, the translational movement amount (ΔX, ΔY) and the rotational movement amount θ can be determined by a least squares method or the like such that a difference between the traveling loci La and Lb in the Y-axis direction of the XY coordinate system is minimized.

(4) The vehicle position recognition apparatus 50 is mounted on the vehicle 101. The vehicle position recognition apparatus 50 further includes: the external sensor group 1 configured to detect the external environment around the vehicle 101; and the map generation unit 17 configured to generate the internal map, which is a map around the vehicle 101, based on the external environment detected by the external sensor group 1 (FIG. 2, FIG. 4). The map information updating unit 52 updates the internal map generated by the map generation unit 17. In other words, the position information of the internal map information, which is dedicated map information for each individual vehicle 101, is corrected and updated based on the external map information, which is general-purpose map information used by many self-driving vehicles including the vehicle 101 and cannot be rewritten on the individual vehicle 101 side.

The above embodiment may be modified into various forms. Hereinafter, some modifications will be described. In the above embodiment, an example in which an internal map such as an environment map and an external map such as a cloud map are combined has been described, but a first map and a second map are not limited thereto. For example, the internal map and the external map acquired from another self-driving vehicle by vehicle-to-vehicle communication may be combined. A plurality of external maps may be combined, or a plurality of internal maps generated by division may be combined. In this case, by dividing and generating the plurality of internal maps so as to generate a sufficient overlapping region, the traveling loci can be suitably superimposed, and the plurality of maps can be accurately combined.

According to the above embodiment, the example in which the vehicle position recognition apparatus 50 constitutes a part of the vehicle control system 100 has been described, but the vehicle position recognition apparatus is not limited to such an example. For example, it may constitute a part of a map information management server or the like provided outside the vehicle 101. In this case, for example, a recognition result (travel history information) of an own vehicle position is acquired from each vehicle, and a plurality of maps are combined on the server side.

In the above embodiment, an example in which a plurality of maps are shifted on the XY plane has been described with reference to FIGS. 3, 5A to 6, and the like. However, even in a case where a plurality of maps are shifted in the Z-axis direction, the plurality of maps can be combined by a similar method.

The above embodiment can be combined as desired with one or more of the above modifications. The modifications can also be combined with one another.

According to the present invention, since a plurality of maps can be accurately combined, variations in recognition results of vehicle positions are eliminated, and smooth traveling control can be performed when traveling in boundary regions of a plurality of maps.

Above, while the present invention has been described with reference to the preferred embodiments thereof, it will be understood, by those skilled in the art, that various changes and modifications may be made thereto without departing from the scope of the appended claims.

What is claimed is:

1. A vehicle position recognition apparatus, comprising:
a processor and a memory connected to the processor, wherein
the memory is configured to store:
first map information of a first map of a first area; and
second map information of a second map of a second area adjacent to the first area through an overlapped area between the first area and the second area, wherein
the processor is configured to perform:
recognizing a first position of a vehicle in the overlapped area based on the first map information stored in the memory;
recognizing a second position of the vehicle in the overlapped area based on the second map information stored in the memory;
generating a first traveling locus of the vehicle in the overlapped area based on a change with time in the first position recognized;
generating a second traveling locus of the vehicle in the overlapped area based on a change with time in the second position recognized; and
updating the first map information so that the first traveling locus and the second traveling locus are matched when the first traveling locus and the second traveling locus are superposed based on the first traveling locus and the second traveling locus generated.

2. The vehicle position recognition apparatus according to claim 1, wherein the processor is configured to perform:
the generating including generating the first traveling locus and the second traveling locus in a time period when the first position and the second position have been recognized.

3. The vehicle position recognition apparatus according to claim 1, wherein
the first map, the second map, the first traveling locus, and the second traveling locus are defined in one single coordinate system, wherein
the processor is configured to perform:
the updating including updating the first map information by determining a translational moving amount and a rotational moving amount of the first map in the coordinate system.

4. The vehicle position recognition apparatus according to claim 1, wherein
the vehicle position recognition apparatus is mounted on the vehicle, wherein
the vehicle position recognition apparatus further comprising:
a detector configured to detect an external environment around the vehicle, wherein
the processor is further configured to perform:
generating a map around the vehicle based on the external environment detected by the detector, wherein
the processor is configured to perform:
the updating including updating the map around the vehicle generated based on the external environment detected by the detector as the first map.

5. A vehicle position recognition apparatus, comprising:
a processor and a memory connected to the processor, wherein
the memory is configured to store:
first map information of a first map of a first area; and
second map information of a second map of a second area adjacent to the first area through an overlapped area between the first area and the second area, wherein
the processor is configured to function as:
a position recognition unit configured to recognize a first position of a vehicle in the overlapped area based on the first map information stored in the memory and configured to recognize a second position of the vehicle in the overlapped area based on the second map information stored in the memory;
a traveling locus generation unit configured to generate a first traveling locus of the vehicle in the overlapped area based on a change with time in the first position recognized by the position recognition unit and configured to generate a second traveling locus of the vehicle in the overlapped area based on a change with time in the second position recognized by the position recognition unit; and
a map information updating unit configured to update the first map information so that the first traveling locus and the second traveling locus are matched when the first traveling locus and the second traveling locus are superposed based on the first traveling locus and the second traveling locus generated by the traveling locus generation unit.

6. The vehicle position recognition apparatus according to claim 5, wherein
the traveling locus generation unit generates the first traveling locus and the second traveling locus in a time period when the first position and the second position have been recognized by the position recognition unit.

7. The vehicle position recognition apparatus according to claim 5, wherein
the first map, the second map, the first traveling locus, and the second traveling locus are defined in one single coordinate system, wherein
the map information updating unit updates the first map information by determining a translational moving amount and a rotational moving amount of the first map in the coordinate system.

8. The vehicle position recognition apparatus according to claim 5, wherein
the vehicle position recognition apparatus is mounted on the vehicle, wherein
the vehicle position recognition apparatus further comprising:
a detector configured to detect an external environment around the vehicle, wherein
the processor is further configured to function as:
a map generation unit configured to generate a map around the vehicle based on the external environment detected by the detector, wherein
the map information updating unit updates the map around the vehicle generated by the map generation unit as the first map.
